(19) United States
(12) Patent Application Publication
(10) Pub. No.: US 2006/0286524 A1
(43) Pub. Date: Dec. 21, 2006

(54) Virtual medical training center

(76) Inventors: Pamela J. Boyers, Plain City, OH (US); Edward T. Bope, Columbus, OH (US); Thomas J. Boes, Worthington, OH (US); Oscar Ruiz, Dublin, OH (US); Jeffrey G. Bell, Columbus, OH (US); Louis J. Unverferth, Columbus, OH (US); Carla Granger, Columbus, OH (US); LaShaun Newton, Columbus, OH (US); Carl Krantz, Columbus, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/131,922

(22) Filed: May 18, 2005

(51) Int. Cl. G09B 23/28

(52) U.S. Cl. 434/262

(57) ABSTRACT

An environment for immersive training of medical personnel through the use of patient simulators in simulated real life conditions. Specifically, a multitude of specifically configured rooms which are outfitted for the support and interfacing of patient simulators including a control room for driving the patient simulators. The control room may be provided in a central location and may include glass, such as one-way glass. The rooms may be adaptable for use in various situations and circumstances.

### FIELD OF THE INVENTION

The present invention is directed to methods for training medical personnel, and more specifically for teaching medical personnel regarding various medical behaviors, techniques and procedures in a virtual environment which simulates, as closely as possible, real life clinical situations.

### BACKGROUND

The teaching of complex medical procedures as well as simulating the clinical situations requiring their administration is a difficult task. Furthermore, given the gravity of the potential consequences of errors made in real life medical situations, it is continually desired to strive to improve methods for teaching such procedures, including critical thinking and clinical judgement, preferably in conditions that simulate real life medical conditions as closely as possible. Traditionally, this has been very difficult to do given the relatively limited ability to effectively simulate real life medical conditions.

Addressing patient safety has become even more critical with the recent rapid increase in the technologies available to treat patients. This expanding universe of new clinical technologies has created a formidable task for individual physicians, nurses, allied health professionals, and for community hospitals that need to continuously maintain their proficiency in order to provide the highest quality of healthcare possible. This is especially challenging for major teaching hospitals who have house staff and nurses who need to be educated from the start. Recently, however, patient simulation devices—or human patient simulators—have been developed which simulate medical patients in an increasingly more realistic manner. Such simulators are being used increasingly and are generally designed to provide a full range of both visual and tactile feedback for the medical personnel who are increasingly being trained through their use.

More specifically, such simulators preferably have the capability of reproducing biological and physiological patient conditions including, but not limited to, spontaneous breathing, pulse, heart and breath sounds and the ability to monitor vital signs such as ECG, pulse oximetry and end-tidal carbon dioxide. Preferably, various medical devices can be attached to the simulators to train users in the proper implementation and use of certain medical equipment (e.g., endotracheal tubes, EKG monitoring, blood pressure, pulse oximetery, defibrillators, and pacing capabilities etc.) as well as the performance of various medical procedures (e.g. chest tube placement and central line insertion, pericardocentesis, needle compression, diagnostic peritoneal lavage etc.). These human patient simulators are typically computer controlled and are capable of being programmed for a wide variety of responses which simulate real life medical conditions. Examples of simulators which would be useful and effective in connection with the present invention include, but are not limited to, the simulators disclosed in U.S. Pat. No. 5,941,710 to Lampotang, et. al., U.S. Pat. No. 5,900,923 to Prendergast, et al., U.S. Pat. No. 5,403,192 to Kleinwaks et al., and in U.S. Pat. No. 3,520,071 to Abrahamson et al., among others, the disclosures of which are incorporated herein by reference.

Advances in these simulators, which are occurring rapidly, have made it possible to teach medical procedures and situations to medical personnel in real life, immersive simulations heretofore unavailable. These simulators, and the software programs associated therewith, have the ability to introduce specific learning objectives and levels of complexity, or procedural consequences, into educational programs heretofore unavailable. Additionally, these simulators generally provide feedback and collect data which allow for the evaluation of the learning objectives using various benchmark metrics. This new technology allows the teaching subject to advance to higher levels of complexity as the subject masters the new skill by demonstrating mastery over increasingly complex procedures as verified by meeting or exceeding the set benchmark metrics. In this way, a teaching subject can gain invaluable experience without having to worry about the downsides associated with unrecoverable consequences to a real patient. Additionally, objective criteria can be used to measure the skill and progression of the teaching subject that was not possible just a few years ago.

However, given the prior unavailability of such sophisticated simulators, there has been very little done, to date, to provide teaching environments and physical spaces that are designed specifically for use with such simulators in order to complement and even augment the real life simulation. U.S. Publication No. 2004/0161731 A1 to Arington et al., the contents of which are herein incorporated by reference, discusses the desirability of linking patient simulators together as a means of improving teaching programs and also discusses the desirability of using linked patient simulators in a “real life” environment designed to look like a trauma suite, operating room, inpatient room or intensive care unit. However, the Arington reference fails to provide or disclose any detail whatsoever for any operable embodiments for setting-up or interconnecting such environments.

Accordingly, given the absence of suitable alternatives in the prior art, it is desired to provide a specific environment and physical space that is designed to accommodate patient simulators in a manner that provides for an immersive, real life teaching environment for medical personnel. It is further desired to provide such an environment which is readily adaptable for different uses, and is specifically configured for supporting and operating patient simulators. It is further desired to provide an environment and physical space which provides the opportunity for controlling, instructing, and observing of medical personnel while being the personnel is being taught various medical procedures and behaviors using patient simulators. Such a setting offers the opportunity to pay special attention to the hand over of care from one level of complexity to another, during which medical errors are considered more likely to occur. This virtual hospital setting allows doctors, nurses and other health professionals, including pre-hospital professionals to practice side-by-side, thus improving greatly the learning of communication skills between health professionals.

### SUMMARY

The present invention provides an environment for immersive training of medical personnel through the use of patient simulators in simulated real life conditions. In one embodiment, the invention comprises a multitude of specifically configured rooms which are outfitted for the support and interfacing of patient simulators. In an embodiment, the configuration of rooms may be provided with a control room for the operating (also known as driving) of patient simulators. In another embodiment, the rooms may be provided with movable walls allowing the reconfiguring of parts or the entirety of the teaching environment as desired based upon the needs of the teaching programs being taught at that time. For example, the walls between the rooms can also be configured to rise into the ceiling, allowing the environment to be used as one large emergency department for triage of casualties and/or to practice disaster preparedness.

More specifically, in one exemplary embodiment, the simulated patient teaching environment of the present invention may include an environment specifically designed to include a multitude of teaching rooms, such rooms being specifically configured as an operating room, an intensive care unit, a trauma suite, a patient or procedure room and a control room. In an embodiment such as this, the control room may be provided in a central location and may include glass, such as one-way glass, that provides patient simulator operators, as well as teaching personnel, the ability to see, communicate with the learners, monitor and control the patient simulators. During these teaching sessions, all activities are recorded and stored using microphones, cameras and AV feeds. In these embodiments, the arrangement of the rooms allows the patient simulators to be “driven” through various echelons, or levels, of care. In other words, as the patient condition changes the patient simulators can “move”—both literally and figuratively from trauma to operating, or from operating to ICU, etc.

In an embodiment, specifically designed and outfitted gas holding closets and communication closets may be provided for housing the computers and gases for supply to the human patient simulators and for providing communication between the patient simulators and the control room, respectively. In this embodiment, the simulation rooms may be provided with raised floors and/or dropped ceilings thereby allowing flexibility for the placement and running of electric cords, computer cords, gas lines, etc. which need to be run between the control room, the communication closets, the patient simulators, and the gas holding closets, respectively. In other embodiments, debriefing rooms may be provided for third party observation as well as preparation before and/or review after simulation exercises.

In other exemplary embodiments of the invention, each room may be built to simulate a real life hospital environment including corresponding equipment and fixtures and may be configured to house an adult, pediatric, or infant patient simulator. In such an embodiment, the provided patient simulators may reproduce breath and heart sounds, pulse readings, drug reactions, as well as thousands of other physiological reactions. In an embodiment, the supplied patient simulators may have the ability to be catheterized, speak, blink eyes, etc. as well as other reflexive and non-reflexive reactions. In an embodiment, the patient simulators may be interchangeable depending on the educational need for a particular educational program. In an embodiment, patient information and documentation may be simulated electronically so that the simulation includes monitoring and charting.

Also, in an embodiment, rooms may be provided with cameras and have additional recording ability to store and retrieve the teaching sessions in order to provide data that can be used to produce benchmark metrics. Metric data that may be collected may include, but is not limited to basic skills, knowledge base, decision making, etc. of the medical personnel being trained The collection and evaluation of these metrics can be used to assist in assessing the effectiveness of training programs, the procedure competency of training subjects, etc.

As described in summary above, the invention provides the ability to teach medical personnel in an immersive, real life environment using patient simulators in a manner heretofore unavailable. Other objects and advantages of the invention will be apparent to one of ordinary skill in the art by review of the specification, drawings, claims and other disclosures herein.

### BRIEF DESCRIPTION OF THE DRAWING

FIG. 1 shows a schematic diagram of a room layout in accordance with an embodiment of the invention.

### DETAILED DESCRIPTION

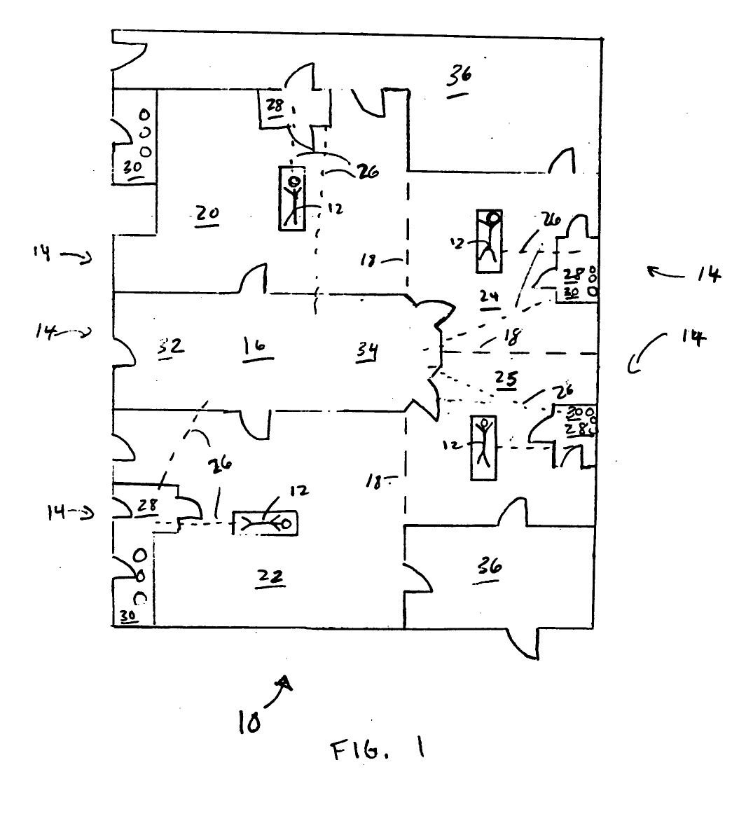

As shown in FIG. 1, the present invention provides an environment 10 for immersive training of medical personnel through the use of patient simulators 12. In one embodiment, the invention comprises a multitude of specifically configured rooms 14 which are outfitted for the support and interfacing of patient simulators 12. The configuration of rooms may be provided with a control room 16 for the operating of the patient simulators 12. The rooms may be provided with movable walls 18 allowing the reconfiguring of parts or the entirety of the environment 10 as desired based upon the needs of the teaching programs being taught at that time. For example, the walls between the rooms 14 can rise, lower, or retract horizontally, allowing the environment 10 to be used as one large emergency department for triage of casualties and to practice disaster preparedness, etc.

More specifically, in one exemplary embodiment, the simulated patient teaching environment 10 of the present invention may include an environment 10 specifically designed to include a multitude of teaching rooms 14, such rooms being specifically configured as an operating room 20, an intensive care unit (ICU) 22, a trauma room or suite 25, a patient and procedure room 24, and a control room 16. In an embodiment such as this, the control room 16 may be provided in a central location and may include glass, such as one-way glass, that provides patient simulator operators, as well as teaching personnel, the ability to see, monitor and control the patient simulators 12. In these embodiments, the arrangement of the rooms 14 preferably allows the patient simulators 12 to be “driven” through various echelons, or levels, of care. In other words, as the patient simulator 12 condition changes, it can “move”, either figuratively or literally, from trauma to operating, or from operating to ICU, etc.

In an embodiment, specifically designed and outfitted gas holding closets 30 and communication closets 28 may be provided for housing gases 38 for supply to the human patient simulators 12 and for providing communication between the patient simulators 12 and the control room 16, respectively. In this embodiment, the simulation rooms 14 may be provided with raised floors and/or dropped ceilings thereby allowing flexibility for the placement and running of electric cords, computer cords, gas lines, etc. which need to be run between the control room 16, the communication closets 28, the patient simulators 12, and the gas holding closets 30, respectively. In other embodiments, learning or debriefing rboms 36 may be provided for third party observation as well as for use by the teaching subjects and teachers for preparation before and/or review after simulation exercises.

In other exemplary embodiments of the invention, each simulation room 14 may be built to simulate a real life hospital environment and may be configured to house an adult, pediatric, or infant patient simulator. In such an embodiment, the provided patient simulators 12 may reproduce breath and heart sounds, pulse readings, drug reactions, as well as thousands of other physiological reactions. In an embodiment, the supplied patient simulators 12 may have the ability to be catheterized, speak, blink eyes, as well as other reflexive and non-reflexive reactions. In an embodiment, the patient simulators may be interchangeable depending on the educational need for a particular educational program.

Preferably, patient information and documentation may be simulated electronically so that the simulation includes monitoring and charting. Also, in an embodiment, rooms 14 may be provided with cameras and other A/V equipment and have additional recording ability in order to provide data that can be used to produce benchmark metrics. Metric data that may be collected may include, but is not limited to, basic skills, knowledge base, decision making, etc. of the medical personnel being trained The collection and evaluation of these metrics can be used to assist in assessing the effectiveness of training programs, the procedure competency of training subjects, etc.

Specifically, with respect to the designation and layout of the simulation rooms 14, it is preferred that the control room 16 constitute a central “hub” for the rest of the simulation rooms 14 and be accessible and visible to/from all of the simulation rooms 14. The control room 16 may be provided with one-way glass to help maintain the real life illusion for the medical personnel teaching subjects. The control room 16 may be provided with a debriefing area 32 and a control area 34. The control room 14 is preferably the place where the teachers and technicians are stationed during simulations. Here, technicians control, drive and execute various clinical scenarios. The control room 16 is preferably equipped with equipment to assist in data/video capture and management. Preferably, there is a 1 to 1 relationship between the simulators 12, the computers and the technicians. The computers may have information relating to actual and/or simulated cases stored therein. The simulators 12 are preferably hardwired to the computers, preferably using cables, etc. 26 which are run under the raised floor or over the dropped ceiling.

Preferably non-simulation, debriefing rooms 36 are also situated to provide access to the simulation rooms 14. The debriefing rooms 36 can be equipped with one way glass for observation of the simulations and may also be used to prepare for and/or review patient simulation exercises. The movable walls 18 are provided to allow total flexibility of the use of all simulation rooms 14, so that they may be used individually or in combination. In combination, the rooms 14 may be used, for example, as a simulated emergency room, triage of casualties, for practice of disaster preparedness, etc.

While various simulation rooms 14 may be provided as desired, in a preferred embodiment simulation rooms 14 comprising an operating room 20, trauma room 22, a patient or procedure room 24, and an ICU 25 are provided. In such a preferred embodiment, the operating room 20 simulates a real operating room where health professionals can be trained and practice various real life operating room procedures and behavior. Such behaviors may include the following: where to stand, how to move, use equipment etc.; how to scrub in preparation for surgery; proper procedure for holding instruments; sterile techniques; patient positioning techniques for surgical procedures; communication techniques; etc. Such procedures may include the following: chest tube placement; tracheotomies; needle decompression of a tension pneumothorax; administering patients anesthetics; use of minimally invasive surgical techniques; monitoring of EKG readings; reacting and responding to emergency/critical situations; airway management techniques; hemorrhage procedures; blood pressure control/reaction procedures; etc. The operating room 20 may be of any desired shape or size as required within the parameters of the invention disclosed herein, and may be approximately 25′ by 25′.

The ICU 25 simulates a real ICU where health professionals can be trained and practice various real life ICU behaviors and procedures. Such behaviors may include the following: where to stand, how to move, use equipment etc.; proper procedure for holding instruments; sterile techniques; patient positioning techniques for ICU procedures; communication techniques; use of ICU technology; managing of complex critical care cases, such as myocardial infarction, pneumothorax, septic shock, pneumonia, respiratory failure; etc. Such procedures may include the following: monitoring of vital signs; infection control; conscious sedation; patient management; etc. The ICU 25 may be of any desired shape or size as required within the parameters of the invention disclosed herein, and may be approximately 16′ by 25′.

The trauma room 22 simulates a real trauma suite where health professionals can be trained and practice various real life trauma behaviors and procedures. Such behaviors may include the following: multidisciplinary team communications; where to stand, how to move, use equipment etc.; proper procedure for holding instruments; sterile techniques; patient positioning techniques for trauma procedures; use of trauma technology; etc. Such procedures may include the following: disaster preparedness; management of the trauma patient for gun shot wounds, motor vehicle accidents, stabbings; monitoring of vital signs; etc. The trauma room 22 may be of any desired shape or size as required within the parameters of the invention disclosed herein, and may be approximately 23′ by 25′.

The patient or procedure room 24 simulates a real patient or procedure room where health professionals can be trained and practice various real life patient or procedure behaviors and procedures. Such behaviors may include the following: where to stand, how to move, use equipment etc.; proper procedure for holding instruments; sterile techniques; patient positioning techniques for patient evaluation or performance of procedures; use of patient or procedure technology; etc. Such procedures may include the following: taking of medical history; physical examination skills; medical management of the patient; patient comfort techniques; respiratory procedures; etc. The patient or procedure room 24 may be of any desired shape or size as required within the parameters of the invention disclosed herein, and may be approximately 16′ by 17′.

While the rooms 14 may be configured permanently in the above-identified configurations, in order to maintain total flexibility, the rooms 14 may also be designed to be interchangeable.

The specific embodiments and examples set forth above are provided for illustrative purposes only and are not intended to limit the scope of the following claims. Additional embodiments of the invention and advantages provided thereby will be apparent to one of ordinary skill in the art and are within the scope of the claims.

What is claimed is:

1. An environment for immersive training of medical personnel utilizing human patient simulators comprising:
a control room;
at least one room configurable as a trauma suite and adapted for interfacing with a human patient simulator;
at least one room configurable as an intensive care unit and adapted for interfacing with a human patient simulator; and
at least one room configurable as a patient or procedure room and adapted for interfacing with a human patient simulator;
wherein said control room is equipped with at least one computer adapted to interface directly with a human patient simulator located in said trauma suite configurable room, intensive care unit configurable room, patient or procedure configurable room.

2. The environment of claim 1 wherein said control room is located at a central position with respect to said trauma suite configurable room, said intensive care unit configurable room, and said patient or procedure configurable room.

3. The environment of claim 1 wherein said control room is directly contiguous to each of said trauma suite configurable room, said intensive care unit configurable room, and said patient or procedure configurable room.

4. The environment of claim 1 further comprising at least one movable divider located between one of said trauma suite configurable room, said intensive care unit configurable room, and said patient or procedure configurable room.

5. The environment of claim 1 further comprising at least one learning or debriefing room located contiguous to one of said trauma suite configurable room, said intensive care unit configurable room, and said patient or procedure configurable room.

6. The environment of claim 5 further comprising a one-way glass window between said learning or debriefing room and one of said trauma suite configurable room, said intensive care unit configurable room, and said patient or procedure configurable room.

7. The environment of claim 1 wherein at least two movable dividers are located between said trauma suite configurable room, said intensive care unit configurable room, and said patient or procedure configurable room allowing reconfiguration of said rooms to form a large emergency department room or disaster preparedness room.

8. The environment of claim 1 wherein said trauma suite configurable room, said intensive care unit configurable room, and said patient or procedure configurable room are provided with raised floors.

9. The environment of claim 1 wherein said trauma suite configurable room, said intensive care unit configurable room, and said patient or procedure configurable room are provided with dropped ceilings.

10. The environment of claim 1 wherein each of said trauma suite configurable room, said intensive care unit configurable room, and said patient or procedure configurable rooms are provided with an associated utility closet.

11. The environment of claim 1 wherein each of said trauma suite configurable room, said intensive care unit configurable room, and said patient or procedure configurable rooms are provided with cameras and associated A/V equipment for recording and monitoring activity in said rooms.

12. The environment of claim 1 wherein said trauma suite configurable room, said intensive care unit configurable room, and said patient or procedure configurable rooms are adapted to house an adult, pediatric, or infant human patient simulator.

13. An environment for immersive training of medical personnel utilizing human patient simulators comprising:
a control room including at least one computer therein;
at least one room configurable as a trauma suite and adapted for interfacing with a human patient simulator;
at least one room configurable as an intensive care unit and adapted for interfacing with a human patient simulator; and
at least one room configurable as a patient or procedure room and adapted for interfacing with a human patient simulator;
at least one room configurable as a debriefing or learning room including at least one window into at least one of said trauma suite configurable room, said intensive care unit configurable room, and said patient or procedure configurable room; and
wherein said control room is adapted to interface directly with a human patient simulator located in said trauma suite configurable room, said intensive care unit configurable room, and said patient or procedure configurable room and is located at a central position thereto.

14. The environment of claim 13 wherein said control room includes a separate door to each of said trauma suite configurable room, said intensive care unit configurable room, and said patient or procedure configurable room.

15. The environment of claim 13 further comprising at least one movable divider located between one of said trauma suite configurable room, said intensive care unit configurable room, and said patient or procedure configurable room.

16. The environment of claim 13 further comprising a learning or debriefing room located contiguous to at least one of said trauma suite configurable room, said intensive care unit configurable room, and said patient or procedure configurable room.

17. The environment of claim 13 wherein each of said trauma suite configurable room, said intensive care unit configurable room, and said patient or procedure configurable rooms are provided with an associated utility closet.

18. The environment of claim 13 wherein each of said trauma suite configurable room, said intensive care unit configurable room, and said patient or procedure configurable rooms are provided with cameras and associated A/V equipment for recording and monitoring activity in said rooms.

19. The environment of claim 1 wherein said trauma suite configurable room, said intensive care unit configurable room, and said patient or procedure configurable rooms are adapted to house an adult, pediatric, or infant human patient simulator.

20. An environment for immersive training of medical personnel utilizing human patient simulators comprising:
a control room including at least one computer therein;
at least one room configurable as a trauma suite and adapted for interfacing with a human patient simulator;
at least one room configurable as an intensive care unit and adapted for interfacing with a human patient simulator; and
at least one room configurable as a patient or procedure room and adapted for interfacing with a human patient simulator;
at least one room configurable as a debriefing or learning room including at least one window into at least one of said trauma suite configurable room, said intensive care unit configurable room, and said patient or procedure configurable room;
wherein said control room is adapted to interface directly with a human patient simulator located in said trauma suite configurable room, said intensive care unit configurable room, and said patient or procedure configurable room and is located at a central position thereto such that it is directly contiguous to and includes at least one window into each of said rooms; and
wherein at least one movable wall is provided between said trauma suite configurable room, said intensive care unit configurable room, and said patient or procedure configurable room.
